(19) United States
(12) Patent Application Publication
(10) Pub. No.: US 2006/0192490 A1
(43) Pub. Date: Aug. 31, 2006

(54) Production method of discharge lamp

(76) Inventors: Yuichiro Ogino, Takatsuki-shi (JP); Yoshimitsu Mino, Soraku-gun (JP); Akio Kikuchi, Hirakata-shi (JP); Hironobu Ueno, Takaishi-shi (JP); Talayuki Murase, Takatsuki-shi (JP)

Correspondence Address: Joseph W Price;Snell & Wilmer, 600 Anton Boulevard, Suite 1400, Costa Mesa, CA, 92626-7689, US

(21) Appl. No.: 10/547,717

(22) PCT Filed: Mar. 10, 2004
(86) PCT No.: PCT/JP04/03068

§ 371 Date: Aug. 31, 2005

(30) Foreign Application Priority Data
Mar. 10, 2003 (JP) 2003-064045

(51) Int. Cl. H01J 61/36; H01J 9/00

(52) U.S. Cl. 313/623; 445/26

(57) ABSTRACT

A discharge lamp manufacturing method that enables the energy loss of a laser beam irradiated from outside an arc tube to be suppressed when forming a pair of electrodes by fusion cutting a predetermined cutting site of a tungsten rod disposed within a sealed arc space. Even when a film of an arc material (e.g., mercury) forms on an inner wall of an arc tube (10) due to the arc material evaporating when the temperature of the arc tube (10) is raised as a result of a laser beam (60) being irradiated from outside the arc tube (10), this manufacturing method is able to eliminate the film through evaporation by heating the arc tube (10) with a coil heater (125) before irradiating the laser beam (60) again.

### TECHNICAL FIELD

The present invention relates to a manufacturing method for discharge lamps, and in particular to a manufacturing method for a short-arc discharge lamp whose interelectrode distance has been shortened to move the electrodes closer to the point light source.

### BACKGROUND ART

In recent years much research and development has gone into various types of projectors for realizing image display on large screens such as LCD (liquid crystal display) projectors and projectors using a DMD (digital micromirror device). Discharge lamps such as short-arc, high-pressure mercury lamps whose interelectrode distance has been reduced to 1.0 mm or less, for example, to move the electrodes closer to the point light source have been attracting attention as a possible light source for such projectors.

A manufacturing method for such discharge lamps disclosed, for example, in Japanese Patent No. 3,330,592 and Japanese Patent Application Publication No. 7-45237 involves inserting an electrode assembly that includes an electrode structural portion for forming a pair of electrodes into a glass bulb for structuring the arc tube of a discharge lamp and creating a seal between the electrode assembly and a section of each of a pair of side-tube parts of the glass bulb that equate to the ends of the arc tube to thus form the arc tube, after which a pair of electrodes are formed within the arc tube by selectively fusion cutting a section (cutting site) of the electrode structural portion.

With this discharge lamp manufacturing method, the cutting site of a tungsten rod positioned within the arc tube is melted and thus cut by the heat from a laser beam irradiated from outside an arc-tube part to form a pair of electrodes.

However, due to the inventors' investigations aimed mainly at the large-scale production of such discharge lamps, it was revealed that energy loss from the laser beam occurs when the laser beam is irradiated a second time from outside the arc tube to melt the tips of the electrodes after the initial laser irradiation to fusion cut the cutting site, thus resulting in a drop in efficiency when using laser irradiation to process the electrode tips. This problem can also arise in the case of laser irradiation being performed two or more times from outside the arc-tube part on the discharge-side tips of two electrode members (e.g., members formed by attaching coil-shaped members to the tips of electrode rods) secured within a sealed arc tube so as to melt the tip of each electrode in the pair.

### DISCLOSURE OF THE INVENTION

The present invention aims to provide a discharge lamp manufacturing method that enables the energy loss of laser irradiation from the second time onward to be suppressed in the case of laser irradiation being performed two or more times to fusion cut an electrode structural portion and/or melt electrode members.

To achieve the above object, a first discharge lamp manufacturing method pertaining to the present invention involves an arc material and a pair of electrode members being introduced into a glass bulb having an arc-tube part and a side-tube part, the electrode member pair being secured by sealing the side-tube part, laser irradiation being performed a plurality of times on the electrode member pair from outside the arc-tube part in order to melt at least a section of each electrode member and form a pair of electrodes, and a process being performed between any of the plurality of laser irradiations to evaporate a film of the arc material that forms on an arc tube inner wall due to laser irradiation.

A second discharge lamp manufacturing method pertaining to the present invention involves an arc material and an electrode assembly that includes an electrode structural portion for forming a pair of electrodes being introduced into a glass bulb having an arc-tube part and a side-tube part, the electrode assembly being secured by sealing the side-tube part, laser irradiation being performed a plurality of times from outside the arc-tube part in order to fusion cut a section of the electrode structural portion and form the pair of electrodes, and a process being performed between any of the plurality of laser irradiations to evaporate a film of the arc material that forms on an arc tube inner wall due to laser irradiation.

The inventors intensive investigations into the reasons for the energy loss from the laser beam described above revealed that mercury enclosed as arc material in the arc tube evaporates due the heat from the first laser irradiation and forms a film of mercury on the inner wall of the arc tube when the temperature of the arc tube drops after the first laser irradiation. The present invention was arrived at based on the observation that the energy loss from subsequent laser beams irradiated from outside the arc tube is caused by this mercury film formed on the arc tube inner wall.

In other words, with the above discharge lamp manufacturing methods pertaining to the present invention, there is no energy loss from the n^{th} (n>1) laser beam, as a result of this laser beam being irradiated after raising the temperature of the arc tube prior to the nth laser irradiation (i.e., any of a plurality of laser irradiations after the first time) to evaporate the film formed on the arc tube inner wall.

The evaporation of the film formed on the arc tube inner wall prior to further laser irradiation is equality desirable for the second laser irradiation onward; namely, for the third, forth and subsequent laser irradiations. At this time, the evaporation of the film may be performed prior to the second laser irradiation only, or prior to the third, forth or subsequent laser irradiations only. Alternatively, the film evaporation may be performed prior to each laser irradiation from the second time onward, or between any of a plurality of laser irradiations.

However, the evaporation of the film need not be carried out when a plurality of laser irradiations are performed with the temperature maintained at the raised level. This is because the film does not form as long as the arc tube is not cooled.

Also, in the case of the temperature of the arc-tube part being raised to eliminate the film, the temperature of the arc-tube part is raised to at least the temperature needed to eliminate, through evaporation, the film of arc material formed on the arc tube inner wall, while keeping the pressure within the arc tube below the pressure resistance of the arc tube.

While it is naturally desirable to optimize this temperature range based of the type and amount of arc material enclosed as well as various other conditions, if the arc-tube part is made from quartz glass and the arc material includes mercury, the temperature when evaporating the film preferably is 1100° C. or below. This is because the inventors' investigations revealed that the quartz glass recrystallizes over this temperature, resulting in the arc-tube part becoming opaque and cloudy.

### BRIEF DESCRIPTION OF THE DRAWINGS

FIG. 1 illustrates a manufacturing method for a discharge lamp in a preferred embodiment of the present invention;

FIG. 2 shows an arc tube 10 after the formation of sealing parts 20 and 20′;

FIG. 3 shows a discharge lamp 100 in which a pair of electrodes 12 and 12′ is formed inside arc tube 10;

FIG. 4 shows a cutting site 18 when a laser beam 60 is first irradiated;

FIG. 5 shows electrode 12 when formed; and

FIG. 6 shows laser beam 60 being irradiated again after heating arc tube 10 using a coil heater 125 to evaporate a deposited film.

### BEST MODE FOR CARRYING OUT THE INVENTION

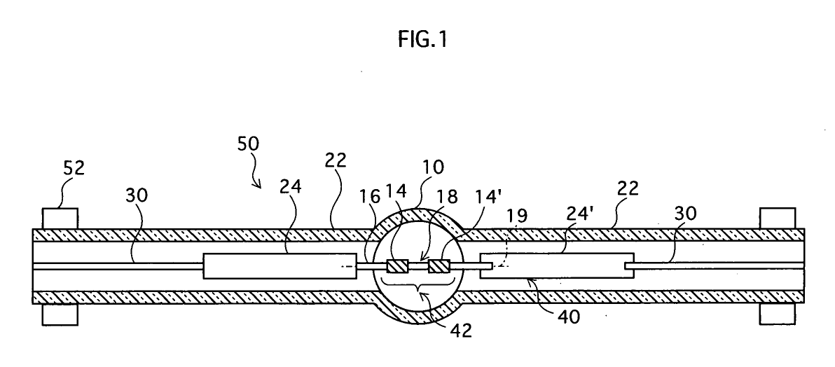

A preferred embodiment of a discharge lamp manufacturing method pertaining to the present invention is described below while referring to the drawings. FIGS. 1 to 3 illustrate a manufacturing method for a high-pressure mercury lamp as an exemplary discharge lamp manufacturing method pertaining to the preferred embodiment of the present invention.

With this embodiment, as shown in FIG. 1, a glass bulb 50 for use in a discharge lamp and a single electrode assembly 40 that includes an electrode structural portion 42 for forming a pair of electrodes in the discharge lamp are firstly prepared, after which electrode assembly 40 is inserted into glass bulb 50.

Glass bulb 50 has a substantially spherical arc-tube part 10 for forming an arc tube of a discharge lamp, and side-tube parts 22 extending from arc-tube part 10. A section of each side-tube part 22 is for forming a sealing part of a discharge lamp. Glass bulb 50 may be held in place by chucks 52, for example. In the present embodiment, glass bulb 50 is held in a horizontal position, but may be held in a vertical position.

Glass bulb 50 is constructed using quartz glass, for example, with an inner diameter of arc-tube part 10 of glass bulb 50 used in the present embodiment being 6.0 mm, a thickness of the glass being 3.0 mm, and each side-tube part 22 having an inner diameter of 3.4 mm and a longitudinal length of 250 mm. Electrode assembly 40 includes a tungsten rod 16 constituting electrode structural portion 42, and metal foils 24 and 24′ joined one at either end of tungsten rod 16.

Metal foils 24 and 24′ can be constructed from molybdenum foil, for example. Tungsten rod 16 is to form the electrode axis of each of the pair of electrodes in the discharge lamp. Tungsten rod 16 has a length of approximately 20 mm and an outer diameter of approximately 0.4 mm, for example. A cutting site 18 to be cut in a later process is in a middle section of tungsten rod 16, and sections of tungsten rod 16 on either side of cutting site 18 are to form the tips of the electrodes, with coils 14 and 14′ being attached respectively to these sections in the present embodiment.

Note that when attaching coils 14 and 14′ to tungsten rod 16, preferably tungsten rod 16 is pressure inserted into coils 14 and 14′ after firstly forming the coils so as to have an inner diameter smaller than the diameter of tungsten rod 16. This is to make the degree of adherence between tungsten rod 16 and coils 14 and 14′ uniform, and thus avoid variations in the condition of the electrodes after processing using the same laser output, since the heat release of the coil sections is then substantially regular in the later process when laser irradiation is used to cut the cutting site. Naturally, the present embodiment is not limited to pressure insertion. For example, the inner diameter of coils 14 and 14′ may be enlarged and tungsten rod 16 attached to the coils using resistance welding after being inserted.

Coils 14 and 14′ function to prevent overheating of the electrode tips during lighting of a manufactured discharge lamp. The outer diameter of the section of electrode structural portion 42 to which coils 14 and 14′ are attached is approximately 1.4 mm, for example. Note that in the present embodiment, central axes 19 of the pair of electrodes can be aligned from the start because of electrode structural portion 42 for forming the pair of electrodes being constituted using a single tungsten rod 16. Tungsten rod 16 and metal foils 24 and 24′ are welded together. Metal foils 24 and 24′ may be flat rectangular sheets, for example, and the dimensions adjusted appropriately. Note that external leads 30 constructed from molybdenum, for example, are welded to metal foils 24 and 24′ at the ends opposite those at which tungsten rod 16 is joined.

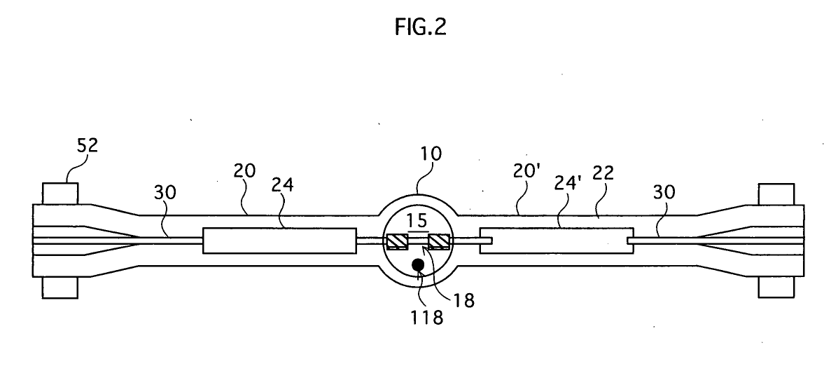

Electrode assembly 40 is inserted so that electrode structural portion 42 is positioned in arc-tube part 10 of glass bulb 50. Next, a seal is created between side-tube parts 22 of glass bulb 50 and sections (metal foils 24 and 24′) of electrode assembly 40 to form sealing parts 20 and 20′ (see FIG. 2) of the discharge lamp. Side-tube part 22 and metal foil 24 may be sealed in accordance with a known method. For example, the pressure within glass bulb 50 may be reduced (e.g., to 20 kPa) after firstly preparing the glass bulb for pressure reduction. A seal can then be created between side-tube part 22 of glass bulb 50 and metal foil 24 to form sealing part 20 by softening side-tube part 22 with a burner while at the same time rotating glass bulb 50 using chucks 52 under reduced pressure.

After forming sealing part 20, the arc material of the discharge lamp can be introduced relatively easily by introducing the arc material into arc-tube part 10 of glass bulb 50 prior to forming the other sealing part 20′. Of course, the arc material may be introduced through a hole opened in arc-tube part 10 after forming sealing parts 20 and 20′, and the hole closed off once the arc material has been introduced.

In the present embodiment, mercury 118 (e.g., approx. 150-200 mg/cm³) is introduced into arc-tube part 10 as arc material, in addition to 5-20 kPa of a rare gas (e.g., argon) and a small amount of a halogen (e.g., bromine). The halogen is not limited to a simple substance (e.g., Br₂), and can be enclosed using a halogen precursor, with bromine in the present embodiment being enclosed using a CH₂Br₂ compound. The role of the enclosed halogen (or a halogen derived from a halogen precursor) is to perform the halogen cycle during lamp operation.

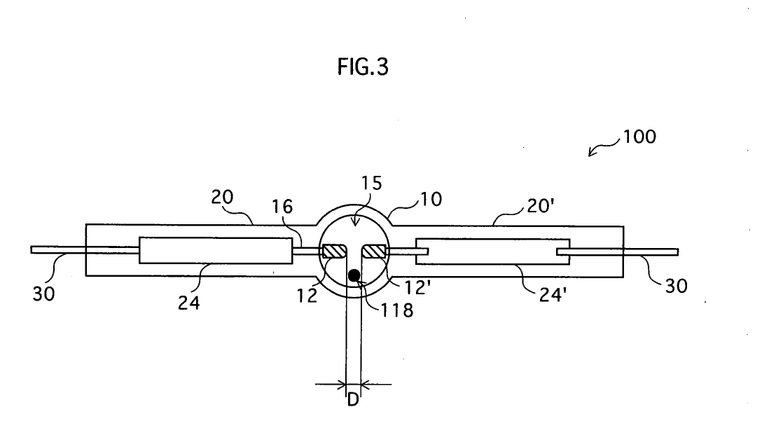

Arc tube 10 having electrode structural portion 42 disposed in an airtight arc space 15, as shown in FIG. 2, is obtained by forming sealing parts 20 and 20′. A pair of electrodes 12 and 12′ having a predetermined interelectrode distance D (see FIG. 3) can then be formed by selectively cutting the cutting site positioned within arc tube 10. In the present embodiment, the tips of electrodes 12 and 12′ are processed into a semi-spherical shape by laser irradiation from outside of arc tube 10, as described in a later section. A discharge lamp 100 having the pair of electrodes 12 and 12′ formed within arc tube 10, as shown in FIG. 3, is then obtained by cutting glass bulb 50 so as to reduce sealing parts 20 and 20′ to a predetermined length.

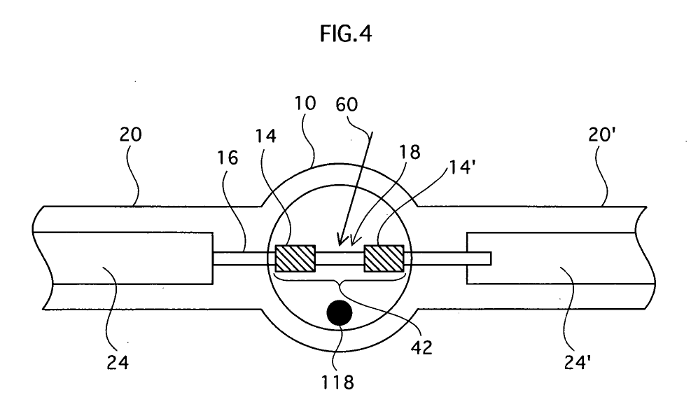

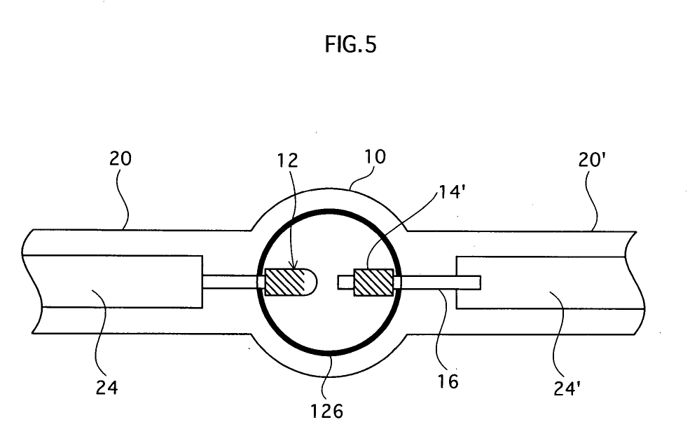

In the present embodiment, the fusion cutting of cutting site 18 is performed by laser irradiation from outside of arc tube 10. FIG. 4 shows cutting site 18 when a laser beam 60 is first irradiated. Irradiating laser beam 60 onto cutting site 18 raises the temperature of cutting site 18 and melts tungsten rod 16 and a section of coil 14, as a result of which tungsten rod 16 separates in two due to surface tension, with one tip of the separated tungsten rod and the section of coil 14 melting together to form a whole. Electrode 12 is thus formed having a semispherical tip due to surface tension. FIG. 5 shows the formed electrode 12.

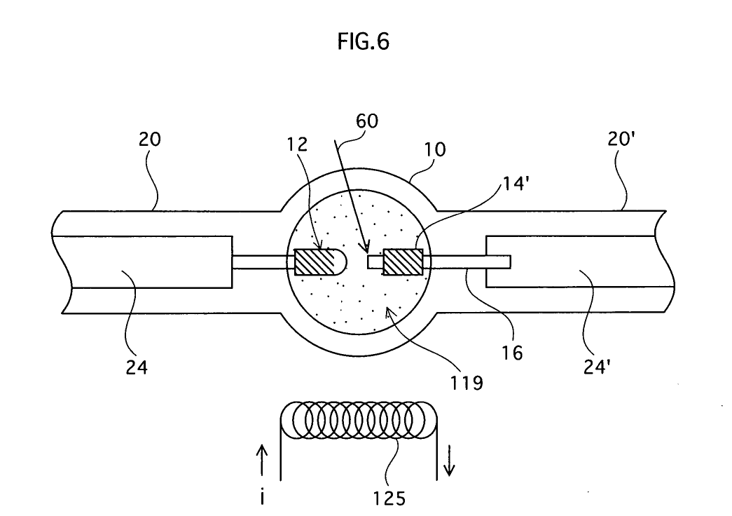

However, the inventors' investigation revealed that mercury 18 enclosed as arc material evaporates when arc tube 10 is heated by the initial laser irradiation, forming an evaporated mercury film 126 on the inner wall of arc tube 10 when the temperature of the arc tube drops after the laser irradiation. The presence of evaporated mercury film 126 results in energy loss from the laser beam when the laser irradiation is performed a second time (see FIG. 6).

In view of this, as shown in FIG. 6, arc tube 10 in the present embodiment is heated using a coil heater 125 prior to irradiating laser beam 60 again to process the other discharge-side tip of the cut tungsten rod 16 into a semispherical shape. Mercury film 126 is eliminated though evaporation as a result of the heating process (i.e., equates to the mercury evaporating step in the present invention, with dots 119 in FIG. 6 representing the evaporated mercury), allowing the laser irradiation to be performed a second time without energy loss.

If energy loss from the laser beam is to be suppressed for the above reasons, the temperature when performing the laser irradiation a second time preferably is maintained within a range that allows a film of arc material (i.e., mercury is not the only arc material that may result in the formation of a film) formed on the inner wall of the arc tube to evaporate, while keeping the pressure within the arc tube below the pressure resistance of the arc tube, even considering the internal pressure increases that result from the increase in temperature.

For example, if mercury is used as arc material, as in the present embodiment, it is possible to arbitrarily regulate the post-heating temperature of the arc tube within a range that allows the mercury film to evaporate, while keeping the pressure within the arc tube below the pressure resistance of the arc tube. The inventors' investigations revealed that a temperature of approximately 300° C. is ideal when mercury 118 is included as arc material, as in the present embodiment. Note that when quartz glass is used in arc-tube part 10, the temperature preferably is kept at or below 1100° C. This is due to evidence that quartz glass recrystallizes at temperatures over 1100° C., becoming opaque and cloudy. Naturally, the preferable temperature range is changeable depending on such conditions as the type and amount of arc material used.

The application of a discharge lamp manufacturing method as described above makes it is possible to suppress energy loss from the second laser irradiation onward, in the case of a laser beam being irradiated two or more times onto a cutting site of an electrode assembly to form a pair of electrodes.

Also, given that the film of arc material (mercury in the present embodiment) formed on the inner wall of the arc tube is eliminated (i.e., through evaporation), the position to which the laser beam is irradiated when performing the next laser irradiation can easily be adjusted using a camera or the like.

Note that a discharge lamp manufactured using a manufacturing method of the present embodiment can be mounted to an image projection device such as an LCD projector or a projector using a DMD, for example, for use as the light source of the projector. This discharge lamp, apart from being used as a light source for projectors, can also be used as a light source in ultraviolet light steppers, sports stadiums, and car headlights etc.

Variations

The present invention, while having been described above based on a preferred embodiment, is naturally not limited to the specific examples shown in this embodiment. For example, the following variations are possible.

(1) While the preferred embodiment, as shown in FIG. 6, is described in terms of coil heater 125 being provided in a vicinity of the arc tube to heat the entire arc tube, the method of heating the arc tube to eliminate the film through evaporation is not limited to this. A variety of heating methods are available including, for example, heating the arc tube using laser irradiation at an output that does not result in fusion cutting, or passing the arc tube through a heated furnace.

(2) The preferred embodiment is described in terms of laser irradiation being performed twice, with the temperature of arc tube 10 being raised prior to the second laser irradiation. While fewer number of laser irradiations is preferable in terms of large-scale production, the heating is of course not limited to being performed prior to the second laser irradiation, and is also desirable when performing the third laser irradiation onward, for example.

(3) While the preferred embodiment is described in terms of tungsten rod 16 equating to the central axis of the pair of electrodes being used in the electrode assembly, the use of a tungsten rod that does not have the same axis as the electrodes is also possible. Also, while the electrode assembly includes molybdenum foils 24 and 24′ joined to tungsten rod 16, the use of an electrode assembly in which molybdenum foils 24 and 24′ are also formed from the tungsten rod is also possible. In this case, leads 30 can also be constructed using the tungsten rod.

(4) In the preferred embodiment, a detailed description is given of the invention when applied in the manufacture of a discharge lamp (so-called super high pressure mercury lamp) in which the vapor pressure of the mercury enclosed as arc material is approximately 20 MPa. However, the possibility also exists of applying the present invention in relation to high-pressure mercury lamps having a mercury vapor pressure of approximately 1.0 MPa or low-pressure mercury lamps having a mercury vapor pressure of approximately 1.0 kPa, in a range in which mercury film 126 can cause energy loss from a laser beam. The present invention is also applicable in relation to discharge lamps other than mercury lamps, including metal halide lamps having a metal halide enclosed therein, for example.

(5) While the preferred embodiment is described in terms of fusion cutting a cutting site of an electrode assembly, the applicable scope of the present invention is not limited to this. The possibility also exists of applying the present invention in the case, for example, of attaching coil-shaped or cylindrical covering members to the discharge-side tips of electrode rods and sealing the sealing parts, before irradiating a laser beam two or more times from outside the arc tube to melt the discharge-side tips of the electrodes. For example, applying the present invention when the tips of each of a pair of electrodes are melted using two or more laser irradiations makes it possible to suppress energy loss from the second laser irradiation onward.

(6) While the present invention is ideally applied in relation to short-arc discharge lamps having a relatively short interelectrode distance D (e.g., 0 mm<D≦4.5 mm, and preferably ≦2.0 mm), the present invention is by no means limited to this range. The present invention can also be applied in relation to direct-current discharge lamps, rather than only alternating-current discharge lamps.

### INDUSTRIAL APPLICABILITY

A manufacturing method pertaining to the present invention can be used to manufacture discharge lamps for suppressing energy loss from the second laser irradiation onward, in the case of laser irradiation being performed two or more times to fusion cut an electrode structural portion and/or melt electrode members.

1. A discharge lamp manufacturing method according to which an arc material and a pair of electrode members are introduced into a glass bulb having an arc-tube part and a side-tube part, the electrode member pair is secured by sealing the side-tube part, and laser irradiation is performed a plurality of times on the electrode member pair from outside the arc-tube part in order to melt at least a section of each electrode member and form a pair of electrodes, wherein
a process is performed between any of the plurality of laser irradiations to evaporate a film of the arc material that forms on an arc tube inner wall due to laser irradiation.

2. A discharge lamp manufacturing method according to which an arc material and an electrode assembly that includes an electrode structural portion for forming a pair of electrodes are introduced into a glass bulb having an arc-tube part and a side-tube part, the electrode assembly is secured by sealing the side-tube part, and laser irradiation is performed a plurality of times from outside the arc-tube part in order to fusion cut a section of the electrode structural portion and form the pair of electrodes, wherein
a process is performed between any of the plurality of laser irradiations to evaporate a film of the arc material that forms on an arc tube inner wall due to laser irradiation.

3. The manufacturing method as in claim 1, wherein the arc-tube part is made from quartz glass, the arc material includes mercury, and a temperature of the arc-tube part when evaporating the film of arc material is 1100° C. or below.

4. The manufacturing method of claim 3, wherein the temperature of the arc-tube part when evaporating the film of arc material is at least 300° C.

5. The manufacturing method as in claim 1, wherein the laser irradiation is performed twice.

6. The manufacturing method of claim 4, wherein the arc-tube part is heated by a third laser irradiation when evaporating the film of arc material.

7. The manufacturing method as in claim 2, wherein the arc-tube part is made from quartz glass, the arc material includes mercury, and a temperature of the arc-tube part when evaporating the film of arc material is 1100° C. or below.

8. The manufacturing method as in claim 2, wherein the laser irradiation is performed twice.
